(19) United States
(12) Patent Application Publication
(10) Pub. No.: US 2016/0253028 A1
(43) Pub. Date: Sep. 1, 2016

(54) TOUCH SENSING APPARATUS AND METHOD FOR DRIVING THE SAME

(71) Applicant: Samsung Display Co., Ltd., Yongin-si (KR)

(72) Inventors: Gi Chang LEE, Asan-si (KR); In Soo WANG, Asan-si (KR); Yong Soo LEE, Seoul (KR)

(21) Appl. No.: 14/854,703

(22) Filed: Sep. 15, 2015

(30) Foreign Application Priority Data
Feb. 26, 2015 (KR) 10-2015-0027323

(51) Int. Cl. G06F 3/041; G06F 3/047; G06F 1/16

(52) U.S. Cl. CPC G06F 3/0416; G06F 1/16; G06F 3/047; G06F 3/0412

(57) ABSTRACT

A touch sensing apparatus that includes a touch panel including first electrodes extending in a first direction and arranged along a second direction, second electrodes extending in the second direction and arranged along the first direction, a signal output unit configured to supply touch driving signals to the first electrodes and configured to receive touch sensing signals generated by the touch driving signals from the first electrodes, and a touch controller configured to calculate a touch position with information from at least one of the first electrodes receiving the touch sensing signals and the first electrodes supplying the touch driving signals corresponding to the touch sensing signals. The second electrodes are connected to corresponding first electrodes and the second electrodes are configured to transfer the touch sensing signals to the corresponding first electrodes.

### CROSS-REFERENCE TO RELATED APPLICATION

This application claims priority from and the benefit of Korean Patent Application No. 10-2015-0027323, filed on Feb. 26, 2015, which is hereby incorporated by reference for all purposes as if fully set forth herein.

### BACKGROUND

1. Field

Exemplary embodiments relate to a touch sensing apparatus and a method for driving the same.

2. Discussion of the Background

In recent years, a touch sensor that may receive input information via touch has become a popular input apparatus. The touch sensor may convert a change in pressure applied to the touch sensor or a change in capacitance occurring at a specific portion into an electrical input signal. The touch sensor may detect a position and an area where a touching object touches the touch sensor, a pressure at the time of touching the touch sensor, capacitance at the time of the touching the touch sensor, and the like. Herein, the touching object may include a finger, a touch pen, a stylus pen, and a pointer.

Common touch sensors types include a resistive-type touch sensor, a capacitive-type touch sensor, an electro-magnetic (EM) type touch sensor, and an optical-type touch sensor.

The capacitive-type touch sensor includes a capacitor that may transfer a signal and sense a change in capacitance. The capacitive-type touch sensor may sense a change in a charged quantity of electric charge, which occurs when a conductor (i.e., a finger) approaches or contacts the touch sensor. This is called a sensing capacitor.

More specifically, a mutual sensing capacitor type is where two electrodes, adjacent to each other, operate the touch sensor. One electrode is applied with a driving signal and the other electrode senses a touch. The mutual sensing capacitor is very useful. However, the touch sensor based on the mutual sensing capacitor type typically has a large (i.e., wide) bezel area for wiring around a region in which the touch electrode is formed. In addition, mutual sensing capacitor touch sensors suffer form inaccuracies in detecting multiple touches. Consumers continue to demand thinner electronic devices (e.g., TVs, monitors, mobile phones, tablets, smart watches, and computers), thus touch sensors with large bezels are harder to fit into these slim devices. Consumers also demand accurate touch sensors.

The above information disclosed in this Background section is only for enhancement of understanding of the background of inventive concept, and, therefore, it may contain information that does not form the prior art that is already known in this country to a person of ordinary skill in the art.

### SUMMARY

Exemplary embodiments provide a touch sensing apparatus having a narrow bezel area.

Exemplary embodiments provide a touch sensing apparatus and a method for driving the same having advantages of improving accuracy of a touch input.

Additional aspects will be set forth in the detailed description which follows, and, in part, will be apparent from the disclosure, or may be learned by practice of the inventive concept.

An exemplary embodiment discloses a touch sensing apparatus that includes a touch panel including first electrodes extending in a first direction and arranged along a second direction, second electrodes extending in the second direction and arranged along the first direction, a signal output unit configured to supply touch driving signals to the first electrodes and configured to receive touch sensing signals generated by the touch driving signals from the first electrodes, and a touch controller configured to calculate a touch position with information from at least one of the first electrodes receiving the touch sensing signals and the first electrodes supplying the touch driving signals corresponding to the touch sensing signals. The second electrodes are connected to corresponding first electrodes and the second electrodes are configured to transfer the touch sensing signals to the corresponding first electrodes.

An exemplary embodiment also discloses a method for driving a touch sensing apparatus that includes a touch panel. The method including supplying touch driving signals to first electrodes of the touch panel, receiving touch sensing signals generated by the touch driving signals from the first electrodes and calculating a touched position based on information from at least one of the first electrodes receiving the touch sensing signals and the first electrodes supplying the touch driving signals corresponding to the touch sensing signals. The first electrodes extend in a first direction and are arranged along a second direction, and the first electrodes are also connected to corresponding second electrode of the touch panel that extend in the second direction are arranged along the first direction.

The foregoing general description and the following detailed description are exemplary and explanatory and are intended to provide further explanation of the claimed subject matter.

### BRIEF DESCRIPTION OF THE DRAWINGS

The accompanying drawings, which are included to provide a further understanding of the inventive concept, and are incorporated in and constitute a part of this specification, illustrate exemplary embodiments of the inventive concept, and, together with the description, serve to explain principles of the inventive concept.

FIG. 1 is a block diagram illustrating a touch sensing apparatus according to an exemplary embodiment.

FIG. 2 is a diagram illustrating a touch panel of the touch sensing apparatus according to the exemplary embodiment.

FIG. 3 is a diagram illustrating one region of the touch panel according to the exemplary embodiment.

FIG. 4 is a diagram illustrating a touch electrode of the touch panel according to the exemplary embodiment.

FIG. 5 is a cross-sectional view of the touch electrode illustrated in FIG. 4 taken along the sectional line A-A′.

FIG. 6 is a circuit diagram illustrating a touch sensing unit of the touch sensing apparatus according to the exemplary embodiment.

FIG. 7 is a timing diagram illustrating a method for driving a touch sensing apparatus according to an exemplary embodiment.

FIGS. 8, 9, 10, 11, 12, 13, and 14 are diagrams illustrating the touch sensing apparatus driving the touch panel according to the exemplary embodiment.

### DETAILED DESCRIPTION OF THE ILLUSTRATED EMBODIMENTS

In the following description, for the purposes of explanation, numerous specific details are set forth in order to provide a thorough understanding of various exemplary embodiments. It is apparent, however, that various exemplary embodiments may be practiced without these specific details or with one or more equivalent arrangements. In other instances, well-known structures and devices are shown in block diagram form in order to avoid unnecessarily obscuring various exemplary embodiments.

In the accompanying figures, the size and relative sizes of layers, films, panels, regions, etc., may be exaggerated for clarity and descriptive purposes. Also, like reference numerals denote like elements.

When an element or layer is referred to as being “on,” “connected to,” or “coupled to” another element or layer, it may be directly on, connected to, or coupled to the other element or layer or intervening elements or layers may be present. When, however, an element or layer is referred to as being “directly on,” “directly connected to,” or “directly coupled to” another element or layer, there are no intervening elements or layers present. For the purposes of this disclosure, “at least one of X, Y, and Z” and “at least one selected from the group consisting of X, Y, and Z” may be construed as X only, Y only, Z only, or any combination of two or more of X, Y, and Z, such as, for instance, XYZ, XYY, YZ, and ZZ. Like numbers refer to like elements throughout. As used herein, the term “and/or” includes any and all combinations of one or more of the associated listed items.

Although the terms first, second, etc. may be used herein to describe various elements, components, regions, layers, and/or sections, these elements, components, regions, layers, and/or sections should not be limited by these terms. These terms are used to distinguish one element, component, region, layer, and/or section from another element, component, region, layer, and/or section. Thus, a first element, component, region, layer, and/or section discussed below could be termed a second element, component, region, layer, and/or section without departing from the teachings of the present disclosure.

Spatially relative terms, such as “beneath,” “below,” “lower,” “above,” “upper,” and the like, may be used herein for descriptive purposes, and, thereby, to describe one element or feature's relationship to another element(s) or feature(s) as illustrated in the drawings. Spatially relative terms are intended to encompass different orientations of an apparatus in use, operation, and/or manufacture in addition to the orientation depicted in the drawings. For example, if the apparatus in the drawings is turned over, elements described as “below” or “beneath” other elements or features would then be oriented “above” the other elements or features. Thus, the exemplary term “below” can encompass both an orientation of above and below. Furthermore, the apparatus may be otherwise oriented (e.g., rotated 90 degrees or at other orientations), and, as such, the spatially relative descriptors used herein interpreted accordingly.

The terminology used herein is for the purpose of describing particular embodiments and is not intended to be limiting. As used herein, the singular forms, “a,” “an,” and “the” are intended to include the plural forms as well, unless the context clearly indicates otherwise. Moreover, the terms “comprises,” “comprising,” “includes, “and/or “including,” when used in this specification, specify the presence of stated features, integers, steps, operations, elements, components, and/or groups thereof, but do not preclude the presence or addition of one or more other features, integers, steps, operations, elements, components, and/or groups thereof.

Various exemplary embodiments are described herein with reference to sectional illustrations that are schematic illustrations of idealized exemplary embodiments and/or intermediate structures. As such, variations from the shapes of the illustrations as a result, for example, of manufacturing techniques and/or tolerances, are to be expected. Thus, exemplary embodiments disclosed herein should not be construed as limited to the particular illustrated shapes of regions, but are to include deviations in shapes that result from, for instance, manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the drawings are schematic in nature and their shapes are not intended to illustrate the actual shape of a region of a device and are not intended to be limiting.

Unless otherwise defined, all terms (including technical and scientific terms) used herein have the same meaning as commonly understood by one of ordinary skill in the art to which this disclosure is a part. Terms, such as those defined in commonly used dictionaries, should be interpreted as having a meaning that is consistent with their meaning in the context of the relevant art and will not be interpreted in an idealized or overly formal sense, unless expressly so defined herein.

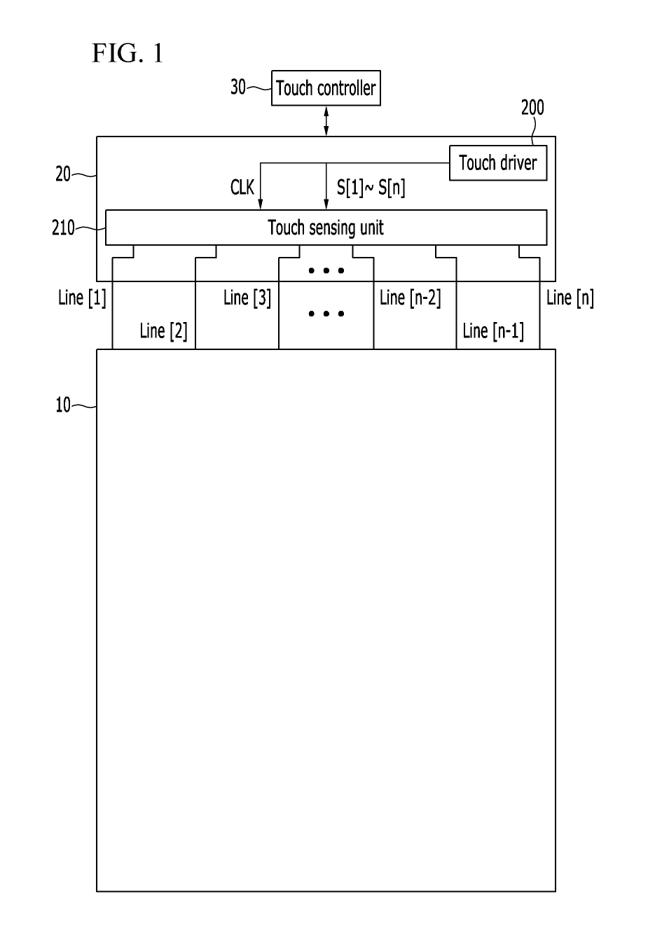

FIG. 1 is a block diagram illustrating a touch sensing apparatus according to an exemplary embodiment. As illustrated in FIG. 1, the touch sensing apparatus includes a touch panel 10, a signal output unit 20, and a touch controller 30, which controls the overall operation of the touch sensing apparatus.

The touch panel 10 is configured to detect a user's touch. When touched, the touch panel 10 may generate a touch sensing signal and supply the touch sensing signal to a touch driver 200 through touch wiring. For example, when a user touches the touch panel 10 with his finger, the touch panel 10 may detect the finger and send the touch sensing signal to the touch driver 200.

Hereinafter, a “pointing implement” indicates objects which may be detected by the touch panel 10, including active type devices, passive type devices and body parts (e.g., finger or palm) of a user

The touch panel 10 is disposed on the display panel to detect touch from a user's pointing implement. The pointing implement may touch a screen displayed on the display panel. The display panel may include at least one of a liquid crystal display (LCD) panel, a thin film transistor-liquid crystal display (TFT LCD) panel, an organic light-emitting diode (OLED) panel, a flexible display panel, a 3D display panel, and an e-ink display panel.

The touch panel 10 may receive a touch driving signal from the signal output unit 20 and generate a touch sensing signal depending on a contact. The touch panel 10 may transmit the generated touch sensing signal to the signal output unit 20.

The touch sensing signal may correspond to raw data supplied by the touch panel 10, such as measurement values of capacitance, voltage, or current for each position within the touch panel 10.

Touch wiring may be connected to a touch driver 200 positioned at one side of the touch region. The touch driver 200 may extend in a vertical direction within a touch region. The touch wiring may include at least one of transparent conductive materials and low resistance metal materials. For example, the touch wiring may be low resistant metal materials such as molybdenum (Mo), silver (Ag), titanium (Ti), copper (Cu), aluminum (Al), and molybdenum/aluminum/molybdenum (Mo/Al/Mo).

The signal output unit 20 may output the touch driving signal from a first touch wiring Line [1] to the n-th touch wiring Line [n] for one frame. The signal output unit 20 may output the touch driving signal every frame.

Further, the signal output unit 20 may output the touch driving signals corresponding to each of the first touch wiring to n-th touch wiring Line [1] to Line [n] at least once for one frame. In this case, the signal output unit 20 may also sequentially output the touch driving signals from the first touch wiring Line [1] to the n-th touch wiring Line [n] once.

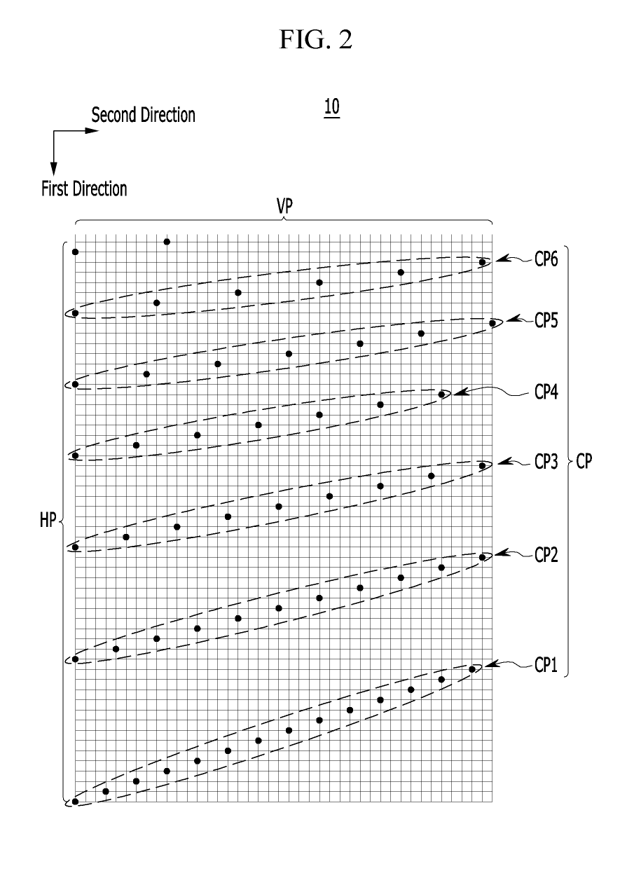

Further, the signal output unit 20 may receive the touch sensing signal while the touch driving signal is outputted. For example, when signal output unit 20 applies the touch driving signal to the first touch wiring Line [1], the signal output unit 20 receives touch sensing signals from a second touch wiring Line [2] to the n-th touch wiring Line [n]. Further, when the signal output unit 20 applies the touch driving signal to the second touch wiring Line [2], the signal output unit 20 receives the touch sensing signals from the first touch wiring Line [1], a third touch wiring Line [3] to the n-th touch wiring Line [n]. In an embodiment, the signal output unit 20 outputs touch driving signals to first electrodes VPs (FIG. 2) though the touch wiring Line [1] to Line [n]. Some first electrodes VPs with adjacent second electrodes HPs (FIG. 2) may generate a touch sensing signal (when the touch panel is touched in this area) and output that touch sensing signal to the second electrodes HPs. First electrode HPs, different from the first electrodes receiving the touch driving signals, receive the touch sensing signal from the second electrodes HPs. The touch sensing signal is then sent to the signal output unit 20 through corresponding touch wiring Line [1] to Line [n].

The signal output unit 20 includes a touch sensing unit 210 and the touch driver 200 which transfers a clock signal CLK and scan signals S[1] to S[n] to the touch sensing unit 210.

As the touch sensing unit 210 is applied with the clock signal CLK and the scan signals S[1] to S[n], the touch sensing unit 210 may transfer the touch driving signal to the touch panel 10 and receive the touch sensing signal. For example, when the clock signal CLK and the first scan signal S[1] are an enable level, the touch sensing unit 210 transfers the touch driving signal to the touch panel 10 through the first touch wiring Line [1] and receives the touch sensing signals from the second touch wiring Line [2] to the n-th touch wiring Line [n].

The touch driver 200 outputs the clock signal CLK that is periodically changed to the enable level. Further, the touch driver 200 outputs the first to n-th scan signals S[1] to S[n], which are changed to the enable level at least once for one frame.

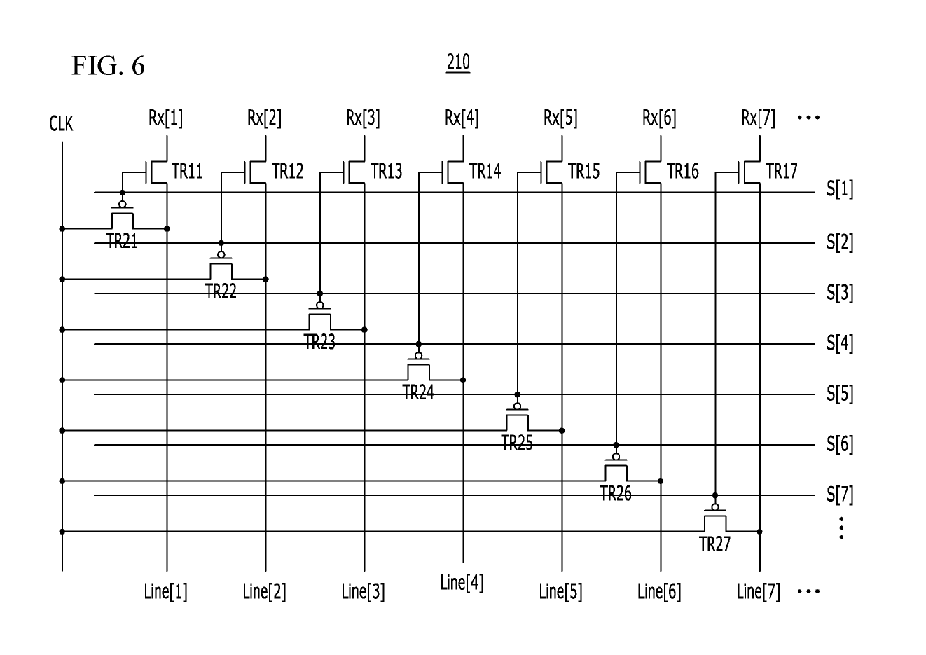

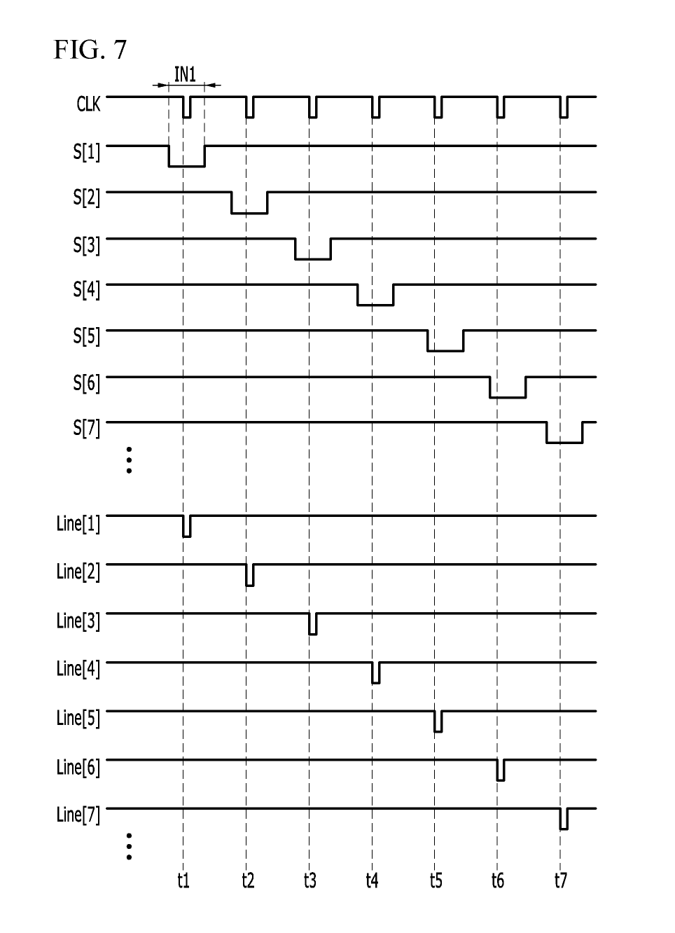

The touch sensing unit 210 and the touch driver 200 will be described below with reference to FIGS. 6 and 7.

The signal output unit 20 outputs information on touch wiring (i.e., a touch driving signal) to the touch controller 30. The signal output unit 20 also receives input information (i.e., a touch sensing signal) on the touch wiring.

The touch controller 30 may process the information (i.e., a touch sensing signal or a corresponding touch driving signal) it receives from signal output unit via the touch wiring to generate touch information like coordinates. Further, the touch controller 30 may output the generated touch information to an external application processor (not shown).

The touch information generated by the touch controller may be a stream of data values corresponding to positions (e.g., changes in capacitance, voltage, or current having a value high enough to detect touch events) that a user touches with a pointing implement. The touch information may further include pressure data which indicate a pressure applied to the touch panel 10 from a pointing implement.

The application processor processes the touch information through software run by the application processor. The application processor may render video images (or frames or video images) that are displayed on the display panel. The application processor may include a central processing unit (CPU) and a graphical processing unit (GPU).

As described above, the touch sensing apparatus may be independent or combined to sense various types of touches such as a short (or tap) touch, a long touch, a multi touch, a drag touch, a flick touch, a pinch-in touch, a pinch-out touch, a swipe touch, a hovering touch, on or over touch panel 10.

According to the exemplary embodiment, the touch panel 10, the signal output unit 20, the touch controller 30, and the display panel may be components of a display module. These display module components may be separate from the application processor. According to another exemplary embodiment, the touch panel 10, the touch driver 200, the touch controller 30, and the display panel or combinations thereof are positioned in separate modules (i.e., not components of a display module) or may be combined with the application processor.

Next, the touch panel 10 according to the exemplary embodiment will be described with reference to FIG. 2.

FIG. 2 is a diagram illustrating the touch panel 10 of the touch sensing apparatus according to the exemplary embodiment. As illustrated in FIG. 2, the touch panel 10 is provided with first electrodes VPs which extend in a first direction (i.e., vertical direction) and second electrodes HPs which extend in a second direction (i.e., horizontal direction) intersecting the first direction. The touch wiring described with reference to FIG. 1 is connected to the corresponding first electrode.

The second electrodes HPs contact corresponding first electrodes VP. The first electrode VP may contact a plurality of second electrodes HPs. Further, the second electrodes HPs, which are disposed adjacent to each other, contact different first electrodes VPs.

In this case, the second electrodes HPs may contact the first electrodes VPs at a predetermined interval. For example, the second electrodes HPs in a first region CP1 of the touch panel 10 are connected to the first electrodes VPs at an interval of three first electrodes VPs. Put another way, every third first electrode VP in the first region CP1 is connected to a second electrode HP). The second electrodes HPs in a second region CP2 are connected to first electrodes VPs at an interval of four first electrodes VPs. In other words, every fourth first electrode VP in the second region CP2 is connected to a second electrode HP. The second electrodes HPs in a third region CP3 are connected to the first electrodes VPs at an interval of five first electrodes VPs. Put another way, every fifth first electrode VP in the third region CP3 is connected to a second electrode HP. The second electrodes HPs in a fourth region CP4 are connected to the first electrodes VPs at an interval of six first electrodes VPs. In other words, every sixth first electrode VP in the fourth region CP4 is connected to a second electrode HP. The second electrodes HPs in a fifth region CP5 are connected to the first electrodes VPs at an interval of seven first electrodes. Put another way, every seventh first electrode VP in the fifth region CP5 is connected to a second electrode HP. The second electrodes HPs in a sixth region CP6 are connected to the first electrodes VPs at an interval of eight first electrodes VPs. In other words, every eighth first electrode VP in the sixth region CP6 is connected to a second electrode HP.

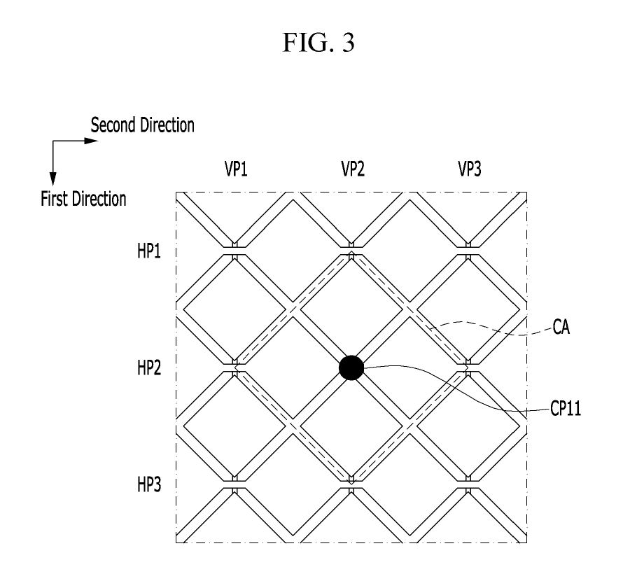

Next, the first electrode VP and the second electrode HP, disposed on the touch panel 10, will be described with reference to FIG. 3.

FIG. 3 is an exemplified diagram illustrating one region of the touch panel 10 according to the exemplary embodiment.

As illustrated in FIG. 3, first electrodes VP1, VP2, and VP3 are arranged along the second direction while extending in the first direction, and second electrodes HP1, HP2, and HP3 are arranged along the first direction while extending in the second direction. The first electrodes VP1, VP2, and VP3 and the second electrodes HP1, HP2, and HP3 may be disposed alternately without overlapping each other.

A first electrode and a second electrode are thus disposed adjacent to each other and form a mutual sensing capacitor that serves as a contact sensing sensor.

The first electrodes VP1, VP2, and VP3 and the second electrodes HP1, HP2, and HP3 may be disposed on the same layer. The first electrodes VP1, VP2, and VP3 and the second electrodes HP1, HP2, and HP3 may have predetermined transmittance (i.e., a transmittance that enables light to transmit through the electrodes VP1, VP2, VP3, HP1, HP2, and HP3). For example, the first electrodes VP1, VP2, and VP3 and the electrodes HP1, HP2, and HP3 may include a thin metal layer of indium tin oxide (ITO), indium zinc oxide (IZO), silver nano wire (AgNw), and metal mesh. As another example, the electrodes VP1, VP2, VP3, HP1, HP2, and HP3 may include of a transparent conductive material such as a carbon nanotube (CNT). However, of the electrodes VP1, VP2, VP3, HP1, HP2, and HP3 are not limited to these materials.

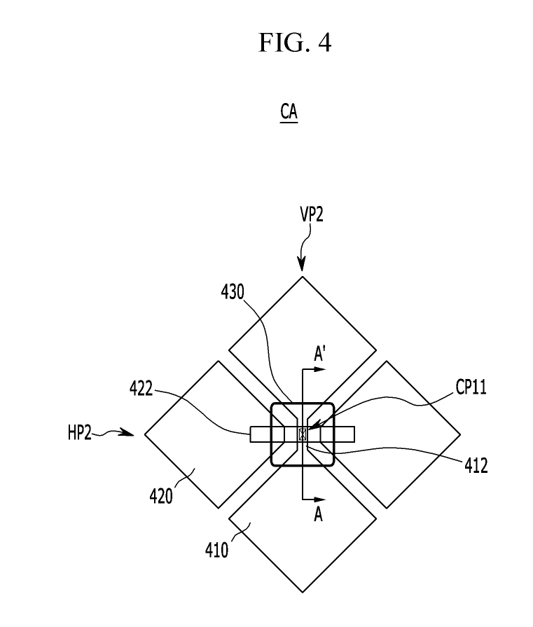

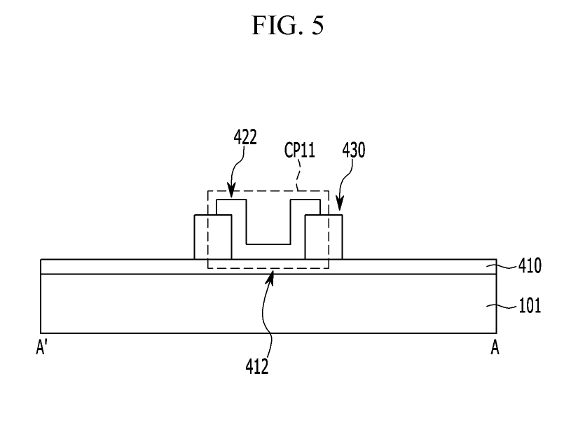

Further, in the region in which the first electrode VP2 and the second electrode HP2 intersect each other, the second electrode HP2 may be connected to the first electrode VP2. Hereinafter, the first electrode VP2 and the second electrode HP2 which are connected to each other will be described in detail with reference to FIGS. 4 and 5.

FIG. 4 is a diagram illustrating one region CA of FIG. 3 where the touch electrodes of the touch panel 10 are arranged. FIG. 5 is a cross-sectional view of the touch electrode illustrated in FIG. 4 taken along the sectional line A-A′.

As illustrated in FIG. 4, a first electrode VP2 includes first electrode pads 410 and a second electrode HP2 includes second electrode pads 420. The first electrode pads 410 and the second electrode pads 420 within the touch panel 10 may be disposed alternately without overlapping each other.

The first electrode pads 410 are disposed in a column and are connected to each other through a first connection part 412. The second electrode pads 420 are positioned in a row and are connected to each other through a second connection part 422.

An insulating may be positioned between the first connection part 412 and the second connection part 422. The insulating layer 430 may be a plurality of independent island type insulators that are disposed at each intersecting part between the first connection part 412 and the second connection part 422.

The first connection part 412, connecting between the first electrode pads 410 that are adjacent to each other, may be positioned on the same layer as the first electrode pad 410 and may include the same material as the first electrode pad 410. Thus, the first electrode pad 410 and the first connection part 412 may be integrated with each other and may be patterned simultaneously.

The second connection part 422, that connects adjacent second touch pads 420, may be disposed on a different layer from the second electrode pad 420. Thus, the first touch electrode 420 and the second connection part 422 may be separated from each other and may be patterned separately. The second electrode pad 420 and the second connection part 422 may be connected to each other by directly touching each other. The insulating layer 430 may have rounded edges. The insulating layer 430 may also have a polygon shape.

Further, the first connection part 412 and the second connection part 422 may be connected to each other through a contact hole (not shown) which is formed on the insulating layer 430. A portion of the first connection part 412 may be exposed through a contact hole in the insulating layer. The insulating layer may contact a portion of the first connection part 412 and the second connection part 422. The contact hole may be formed such that a portion of the second connection part 422 and a portion of the first connection part 412 contact each other.

Referring to FIG. 5, the first connection part 412 connecting first electrode pad 410 is disposed on the substrate 101. Further, the insulating layer 430 having an island shape is disposed on the first connection part 412.

The insulating layer 430 is formed to expose a portion of the first connection part 412. Next, the second connection part 422 may be disposed on the insulating layer 430 and the exposed portion of the first connection part 412.

Although not shown in FIGS. 4 and 5, an alternate embodiment includes the second connection part 422 connecting adjacent second electrode pads 420 disposed on the same layer as the second electrode pads 420. In this embodiment, with the second connection part 422 is integrated with the second electrode pads 420. The first connection part 412 connecting adjacent first electrode pads 410 may be disposed on a different layer from the first electrode pads 410.

FIGS. 4 and 5 illustrate the insulating layer 430 may not be formed in the region that the first electrode pads 410 and the second electrode pads 420 (not shown) are connected to each other.

Next, the touch sensing unit 210 will be described in detail with reference to FIGS. 6 and 7.

FIG. 6 is a circuit diagram illustrating a portion of the touch sensing unit 210 of the touch sensing apparatus according to the exemplary embodiment. FIG. 7 is a timing diagram illustrating a method for driving a touch sensing apparatus according to an exemplary embodiment.

As illustrated in FIG. 6, the touch sensing unit 210 includes a clock signal input terminal. The touch driver 200 inputs a clock signal CLK to the clock signal input terminal of the touch sensing unit 210. The touch driver 200 also inputs scan signals S[1] to S[7] to the touch sensing unit 210. The touch sensing unit 210 includes receiving terminals Rx[1] to Rx[7] configured to receive the touch sensing signal, first transistors TR11, TR12, TR13, TR14, TR15, TR 16, and TR17 connected to the corresponding receiving terminals. The touch sensing unit 210 also includes second transistors TR21, TR22, TR23, TR24, TR25, TR26, and TR27. The touch driver 200 or the touch sensing unit 210 may be configured to apply the clock signal CLK and scan signals S[1] to S[7] to the second transistors TR21 to TR27.

The first transistors TR11 to TR17 have a first terminal connected to the corresponding receiving terminals Rx[1] to Rx[7]. The first transistors TR11 to TR17 have a second terminal connected to corresponding touch wirings Line [1] to Line [7]. The first transistors TR11 to TR17 have a gate connected to corresponding scan lines. The first transistors TR11 to TR17 are turned on or turned off, depending on a level of the scan signals S[1] to S[7] supplied to the scan lines, to transfer the touch sensing signals supplied from the touch wirings Line [1] to Line [7] to the receiving terminals Rx[1] to Rx[7].

The second transistors TR21 to TR27 have a first terminal connected to clock signal input terminals, a second terminal connected to corresponding touch wirings Line [1] to Line [7], and a gate connected to corresponding scan lines. The second transistors TR21 to TR27 are turned on or turned off, depending on the level of the scan signals S[1] to S[7] supplied to the scan lines, to transfer the clock signal CLK to the touch wiring Line [1] to Line [7].

The first transistors TR11 to TR17 and the second transistors TR21 to TR27 are complementarily controlled. For example, the first transistors TR11 to TR17 are turned on by a high-level scan signal, but the second transistors TR21 to TR27 are turned on by a low-level scan signal. Likewise, the first transistors TR11 to TR17 are turned off by a low-level scan signal, but the second transistors TR21 to TR27 are turned off by a high-level scan signal. The first transistors TR11 to TR17 may include a p-type metal-oxide-semiconductor (“PMOS”) and the second transistors TR21 to TR27 may include an n-type metal-oxide-semiconductor (“NMOS”).

As illustrated in FIG. 7, the clock signal CLK is periodically changed to a low level within one frame. The clock signal CLK is changed to a low level at timing t1, t2, t3, t4, t5, t6, and t7 for a predetermined time interval (e.g., IN1). The clock signal CLK is otherwise at a high level.

Further, the scan signals S[1], S[2], S[3], S[4], S[5], S[6], and S[7] are at a low level at timings t1 to t7, which corresponds to an interval (e.g., IN1) of the clock signal CLK. The corresponding clock signal is changed to a low level within one frame. For example, the first scan signal S[1] is at a low level within a first period IN1 including a first timing t1 and remains at a high level in other periods (i.e., not IN1).

Further, the scan signals S[1] to S[7] may be sequentially changed to a low level. For example, after the timing at which the first scan signal S[1] is changed to a low level (IN1), the second scan signal S[2] is changed to a low level at a second period IN2 (not shown).

Because the first scan signal S[1] is a low level in a first period IN1, the second transistor T21 connected to the first touch wiring Line[1] is turned on and the first transistor TR11 is turned off. When the clock signal CLK is changed to a low level at the first timing t1, the second transistor TR21 is turned on, the clock signal CLK is output to the first touch wiring Line[1] as the touch driving signal.

Because the second scan signal to the seventh scan signal S[2] to S[7] are at a high level in the first period IN1, the first transistors TR12 to TR17, connected to corresponding second touch wiring to the seventh touch wiring Line[2] to Line[7] are turned on and the second transistors TR22 to TR27 are turned off. Therefore, the touch sensing signals are transferred from the second touch wiring to the seventh touch wiring Line[2] to Line[7] to receiving terminals Rx[2] to Rx[7].

Although only the first scan signal S[1] within the first period IN1 is described above, the exemplary embodiment may be identically applied to the scan signals S [2] to S [7] other than the first scan signal S[1].

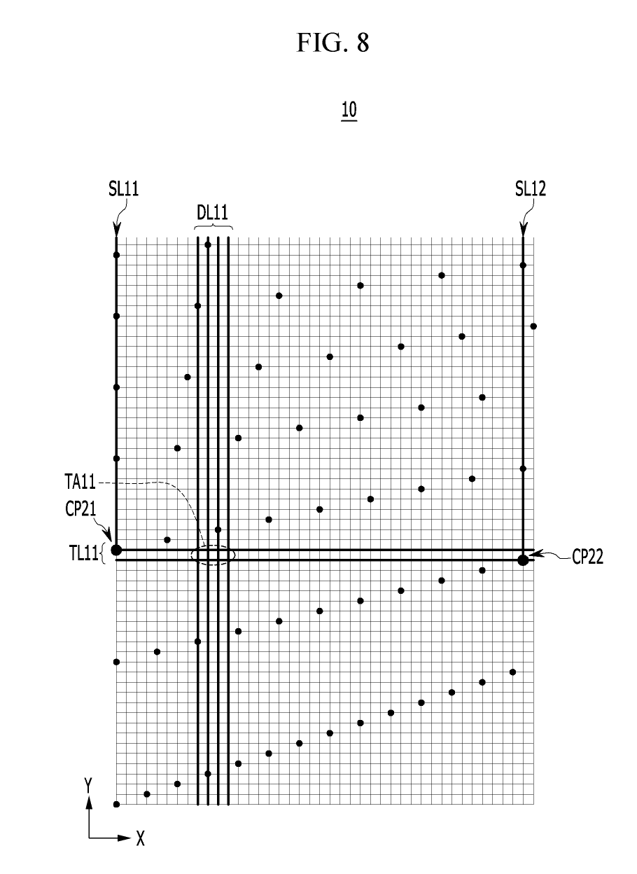

Next, a method for sensing a touch with the touch panel 10 will be described with reference to FIGS. 8, 9, 10, 11, 12, 13, and 14.

FIGS. 8 to 14 are diagrams illustrating the driving touch panel 10 of the touch sensing apparatus according to the exemplary embodiment.

FIG. 8 is a diagram illustrating electrodes that receive a touch driving signal and a touch sensing signal for a first point when a pointing implement touches the first point TA11 of the touch panel 10.

The touch driving signal is applied to a first electrode DL11 within one frame. A second electrode adjacent to the first electrode DL11 and the first electrode DL11 form a capacitor to provide an electric charge in response to the touch driving signal.

As the pointing implement touches a first point TA11, the touch sensing signal is generated by the adjacent first electrode DL11 and the second electrode from the touch driving signal. The touch sensing signal is transferred to second electrodes TL11 corresponding to the first point TA11. The second electrodes TL11 are each connected to first electrodes SL11 and SL12 through contact points CP21 and CP22.

Next, the touch sensing signals are transferred from each of the second electrodes TL11 to the first electrodes SL11 and SL12. The touch sensing signals are inputted to a receiving terminal of the touch sensing unit 210 through corresponding touch wiring (i.e., Line[1] to Line [n].

The signal output unit 20 outputs information from the first electrodes SL11 and SL12 and outputs information from the first electrode DL11 to the touch controller 30. For example, the signal output unit 20 outputs the information from the first electrode DL11 (i.e., that the touch driving signal is applied at an i-th timing to the first electrode DL11) and information from the first electrodes SL11 and SL12 (i.e., that the touch sensing signal is applied to the first electrode SL11 and SL12 at the same i-th timing) to the touch controller 30.

Next, the touch controller 30 uses the information from the first electrode DL11 (i.e., information corresponding to the touch driving signal) to be able to calculate x-axis coordinates of the first point TA11. Further, the touch controller 30 may calculate y-axis coordinates of the first point TA11 based on patterns of the first electrodes SL11 and SL12 (i.e., touch sensing signal patterns).

The second electrodes HPs (i.e. TL11s) are connected to corresponding first electrodes VPs (i.e., SL11). The second electrodes HPs are adjacently disposed to contact different first electrodes VPs in patterns of the first so that touch sensing signals from the first electrodes may be distinguished from one another depending on the particular touched point. Therefore, the touch controller 30 may calculate y-axis coordinates of the touched point based on receiving touch sensing signals (or information regarding these signals) from the first electrodes VPs because of the particular the pattern in which the first electrodes are arranged.

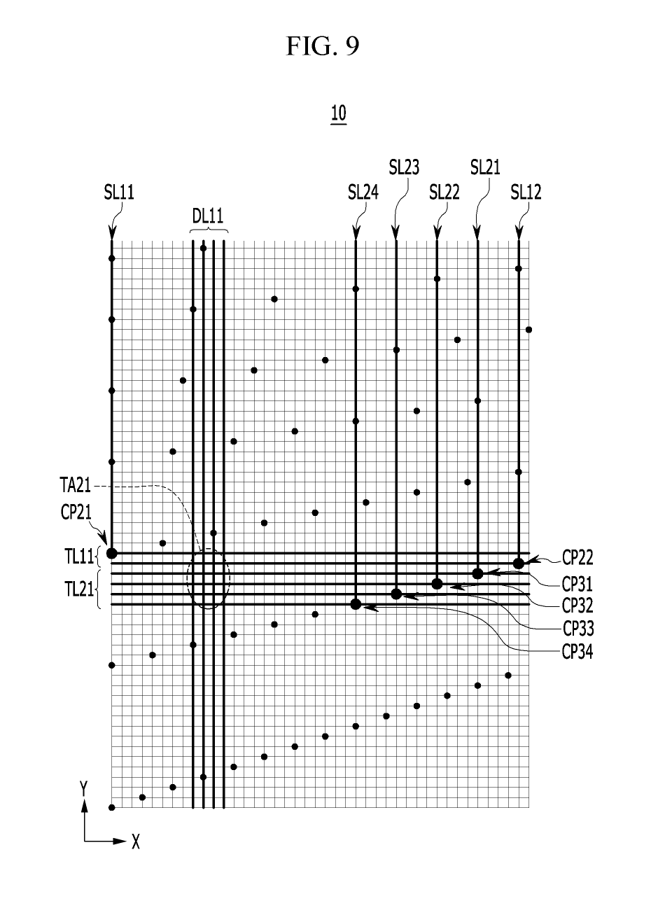

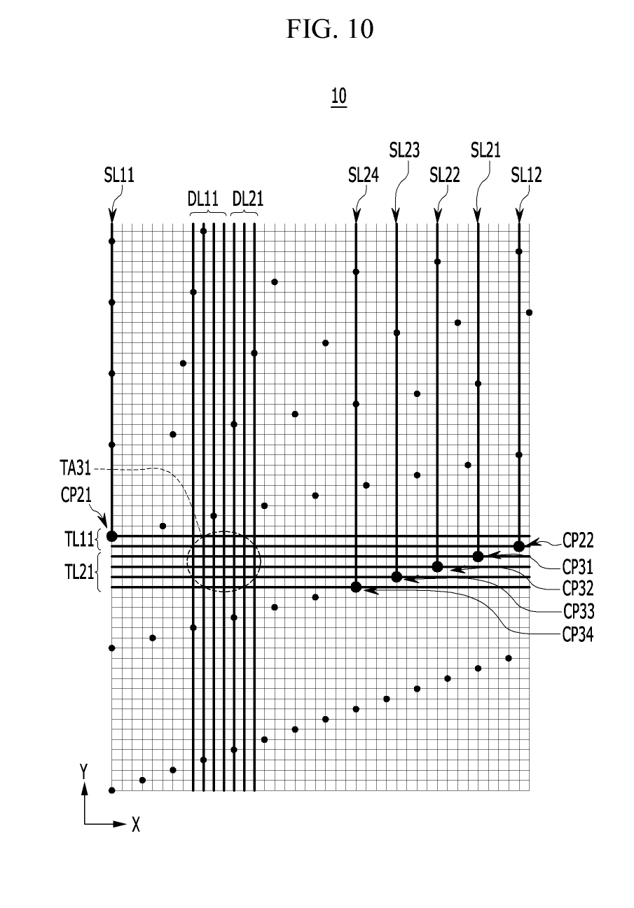

An example in which the information on the first electrode and the information on the second electrode are differently formed in response to the area of the touched point even when the same point is generally touched will be described with reference to FIGS. 9 and 10.

As illustrated in FIG. 9, the touch driving signal is applied to a first electrode DL11 within one frame. A second electrode adjacent to the first electrode DL11 and the first electrode DL11 form a capacitor to provide an electric charge in response to the touch driving signal.

As the pointing implement touches a second point TA21, the touch sensing signals are transferred to the second electrodes TL11 and TL21 corresponding to the second point TA21. Compared to the touch position of the first point TA11 of FIG. 8, the touched position of the first point TA21 of FIG. 9 is generally the same. However, a touched area of the second point TA21 of FIG. 9 is larger in the y-axis than that of the first point TA11 of FIG. 8. Therefore, the touch sensing signal is also transferred to the second electrodes TL21 in addition to the second electrodes TL11.

The second electrodes TL11 are each connected to the first electrodes SL11 and SL12 through contact points CP21 and CP22. The second electrodes TL21 are each connected to first electrodes SL21, SL22, SL23, and SL24 through contact points CP31, CP32, CP33, and CP34.

Next, the touch sensing signals are transferred from each of the second electrodes TL11 to the first electrode SL11 and SL12 and the touch sensing signals are transferred from each of the second electrodes TL21 to the first electrodes SL21, SL22, SL23, and SL24. The touch sensing signals are sent to the receiving terminal of the touch sensing unit 210 through the corresponding touch wiring.

The signal output unit 20 outputs information from the first electrodes SL11, SL12, SL21, SL22, SL23, and SL24 (i.e., information regarding the touch sensing signal)_{—} and information from the first electrode DL11 (i.e., information regarding, the touch driving signal corresponding to the touch sensing signal), to the touch controller 30.

Next, the touch controller 30 uses the information on the first electrodes DL11 to calculate x-axis coordinates of the second point TA21. Further, the touch controller 30 may calculate y-axis coordinates of the second point TA21 based on patterns of the first electrodes SL11, SL12, SL21, SL22, SL23, and SL24 (i.e., touch sensing signal patterns).

Further, as illustrated in FIG. 10, the touch driving signal is applied to the first electrodes DL11 and DL21 within one frame. A second electrode adjacent to the first electrodes DL11 and DL21 and the first electrodes DL11 and DL21 form a capacitor to provide an electric charge in response to the touch driving signal.

As the pointing implement touches a third point TA31, the touch sensing signals are transferred to the second electrodes TL11 and TL21 corresponding to the third point TA31.

The second electrodes TL11 are each connected to the first electrodes SL11 and SL12 through the contact points CP21 and CP22. The second electrodes TL21 are each connected to the first electrodes SL21, SL22, SL23, and SL24 through the contact points CP31, CP32, CP33, and CP34.

Next, the touch sensing signals are transferred from each of the second electrodes TL11 to the first electrode SL11 and SL12 and the touch sensing signals are transferred from each of the second electrodes TL21 to the first electrodes SL21, SL22, SL23, and SL24. The touch sensing signal sent to the receiving terminal of the touch sensing unit 210 through corresponding touch wiring.

The signal output unit 20 outputs information from the first electrodes SL11, SL12, SL21, SL22, SL23, and SL24 (i.e., touch sensing signal information) and information from the first electrodes DL11 and DL12 (i.e., touch driving signal information corresponding to the touch sensing signal information) to the touch controller 30.

Next, the touch controller 30 uses the information from the first electrodes DL11 and DL12 to calculate x-axis coordinates of the third point TA31. Further, the touch controller 30 may calculate y-axis coordinates of the third point TA31 based on the patterns of the first electrodes SL11, SL12, SL21, SL22, SL23, and SL24 (i.e., touch sensing signal patterns).

Compared with FIG. 9, the touched positions of the second point TA21 of FIG. 9 and the third point TA31 of FIG. 10 are generally the same. However, a touched area of the third point TA31 is larger in the x-axis than that the second point TA21 of FIG. 9. Therefore, the x-axis coordinates of the third point TA31 are calculated differently from the second point TA21 by using the first electrodes DL11 and DL12 (i.e., the electrodes that apply the touch driving signals).

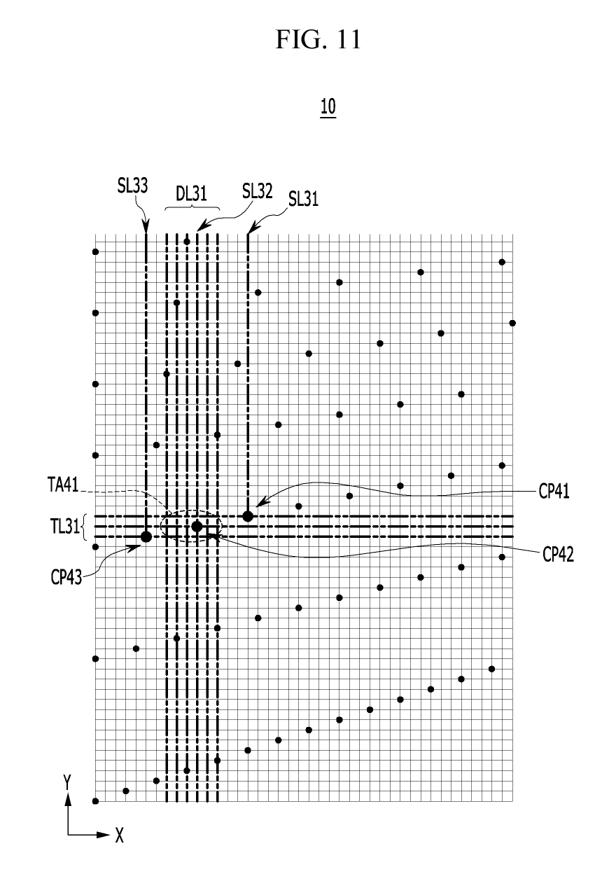

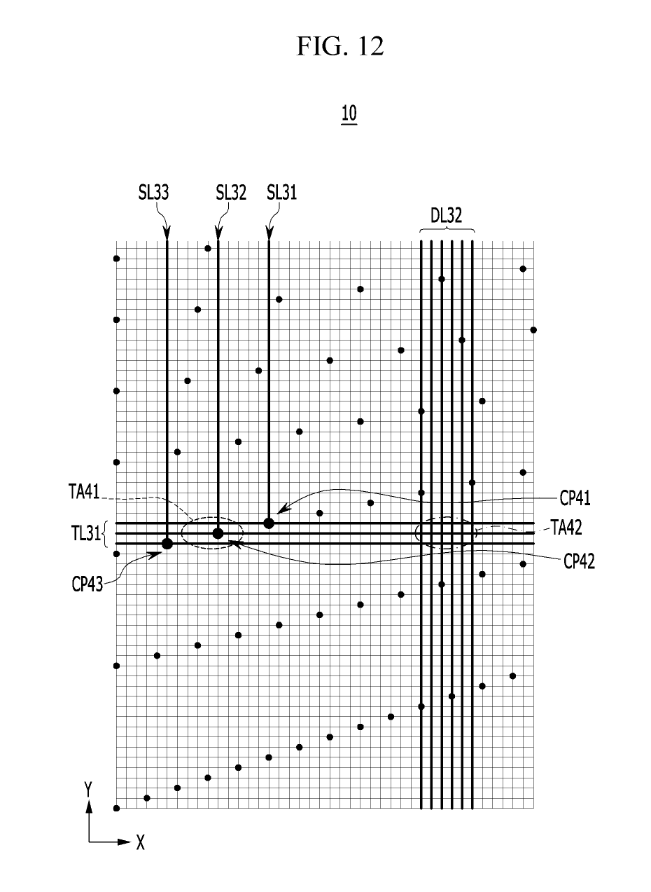

Next, a method for sensing a touch when two points having the generally same y-axis position are consecutively touched will be described with reference to FIGS. 11 and 12.

As illustrated in FIG. 11, the touch driving signal is applied to the first electrode DL31 within one frame. The second electrode adjacent to the first electrode DL31 and the first electrode DL31 form a capacitor to charge an electric charge in response to the touch driving signal.

As a pointing implement touches a fourth point TA41, the touch sensing signal is generated by the adjacent first electrode DL31 and the second electrode from the touch driving signal. The touch sensing signal is transferred to second electrodes TL31 corresponding to the fourth point TA41. The second electrodes TL31 are each connected to first electrodes SL31, SL32, and SL33 through contact points CP41, CP42, and CP43.

Next, the touch sensing signals are transferred from each of the second electrodes TL31 to the first electrodes SL31, SL12, and SL33. The touch sensing signal are send to the receiving terminal of the touch sensing unit 210 through corresponding touch wiring.

The signal output unit 20 outputs information from the first electrodes SL31, SL32, and SL33 (i.e., touch sensing signal information) and information from the first electrode DL31 (i.e., touch driving signal information corresponding to the touch sensing signal information) to the touch controller 30. For example, the signal output unit 20 outputs the information from the first electrode DL31 (i.e., information that the touch driving signal was applied at the i-th timing) and the information from the second electrode (i.e., information that the touch sensing signal was allied at the i-th timing) to the touch controller 30.

Next, the touch controller 30 uses the information from the first electrode DL31 to calculate x-axis coordinates of the fourth point TA41. Further, the touch controller 30 may calculate y-axis coordinates of the fourth point TA41 based on patterns of the first electrodes SL31, SL32, and SL33 (i.e., touch sensing signal patterns).

As illustrated in FIG. 12, the touch driving signal is applied to the first electrodes DL32 for the next frame. The second electrode adjacent to the first electrodes DL32 and the first electrodes DL32 form a capacitor to provide an electric charge in response to the touch driving signal.

As the touching implement touches a fifth point TA42 having the generally same y-axis coordinates as the fourth point TA41, the touch sensing signal is generated by the adjacent first electrode DL32 and the second electrode. The touch sensing signal is transferred to the second electrode TL31 corresponding to the fifth point TA42. The second electrodes TL31 are each connected to the first electrodes SL31, SL32, and SL33 through the contact points CP41, CP42, and CP43.

Next, the touch sensing signals are transferred from each of the second electrodes TL31 to the first electrodes SL31, SL12, and SL33. The touch sensing signals are sent to the receiving terminal of the touch sensing unit 210 through corresponding touch wiring.

The signal output unit 20 outputs information from the first electrodes SL31, SL32, and SL33 (i.e., touch sensing signal information) and information from the first electrode DL32 (i.e., touch driving signal information corresponding to the touch sensing signal information) to the touch controller 30.

Next, the touch controller 30 uses the information from the first electrode DL32 to calculate x-axis coordinates of the fifth point TA42. Further, the touch controller 30 may calculate y-axis coordinates of the fifth point TA42 based on patterns of the first electrodes SL31, SL32, and SL33 (i.e., touch sensing signal patterns). When the touching implement touches the fifth point TA42, the touch sensing signals are transferred to the same first electrodes SL31, SL32, and SL33 as the if the touching implement touched the fourth point TA41. Therefore, the y-axis coordinates of the fifth point TA42 may be calculated similar to the y-axis coordinates of the fourth point TA41.

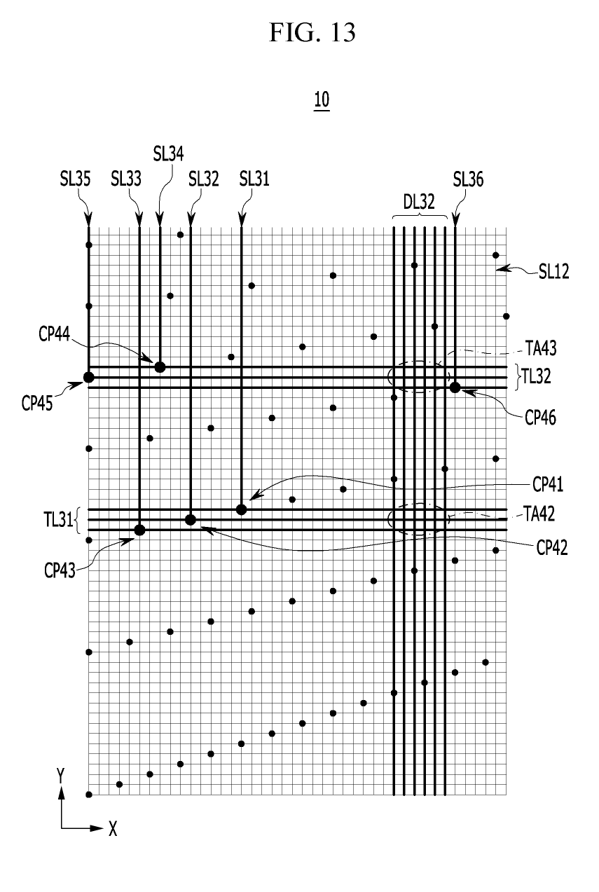

Next, a method for sensing a touch when two points having the generally same x-axis position are simultaneously touched will be described with reference to FIG. 13.

As illustrated in FIG. 13, the touch driving signal is applied to the first electrodes DL32 within one frame. The second electrodes adjacent to the first electrodes DL32 and the first electrodes DL32 form a capacitor to provide an electric charge in response to the touch driving signal.

As two touching implements touch the fifth point TA42 and the sixth point TA43 simultaneously, the touch sensing signals are transferred to the second electrode TL31 corresponding to the fifth point TA42 and the second electrode TL32 corresponding to the sixth point TA43. The second electrodes TL31 are each connected to the first electrodes SL31, SL32, and SL33 through the contact points CP41, CP42, and CP43. The second electrodes TL32 are each connected to first electrodes SL34, SL35, and SL36 through contact points CP44, CP45, and CP46.

Next, the touch sensing signals are transferred from each of the second electrodes TL31 to the first electrodes SL31, SL32, and SL33 and the touch sensing signals are transferred from each of the second electrodes TL32 to the first electrodes SL34, SL35, and SL36. The touch sensing signals are sent to the receiving terminal of the touch sensing unit 210 through corresponding touch wiring.

The signal output unit 20 outputs information from the first electrodes SL31, SL32, SL33, SL34, SL35, and SL36 (i.e., touch sensing signal information) and the information from the first electrode DL32, from which the touch driving signal corresponding to the touch sensing signal is output, to the touch controller 30.

Next, the touch controller 30 uses the information from the first electrode DL32 to calculate the x-axis coordinates of the fifth point TA42 and the sixth point TA43. Further, the touch controller 30 may calculate the y-axis coordinates of the fifth point TA42 based on the patterns of the first electrodes SL31, SL32, and SL33 (i.e., touch sensing signal patterns) and calculate the y-axis coordinates of the sixth point TA43 based on the patterns of the first electrodes SL34, SL35, and SL36.

The x-axis coordinates are calculated as the same, but the y-axis coordinates are calculated differently. Therefore, the touch controller 30 may separately generate the touch information on the fifth point TA42 and the sixth point TA43.

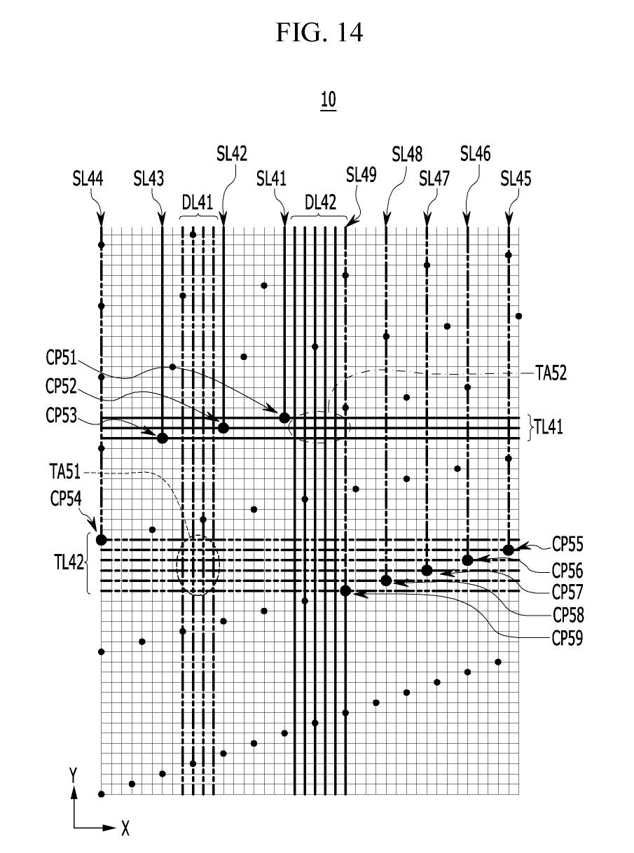

Next, a method for sensing a touch when two different points are touched will be described with reference to FIG. 14.

As illustrated, the touch driving signals are sequentially applied to the first electrodes DL41 and DL42 within one frame. First, the second electrodes adjacent to the first electrodes DL41 and the first electrodes DL41 form a capacitor to provide an electric charge in response to the touch driving signal.

As a touching implement touches a seventh point TA51, the touch sensing signal is generated by the adjacent first electrodes DL41 and the second electrodes from the touch driving signal. The touch sensing signal is transferred to the second electrode TL42 corresponding to the seventh point TA51. The second electrodes TL42 are each connected to first electrodes SL44, SL45, SL46, SL47, SL48, and SL49 through contact points CP54, CP55, CP56, CP57, CP58, and CP59.

Next, the touch sensing signals are transferred from each of the second electrodes TL42 to the first electrodes SL44 to SL49. The touch sensing signals are sent to the receiving terminal of the touch sensing unit 210 through corresponding touch wiring.

Next, the second electrodes adjacent to the first electrodes DL42 and the first electrode DL42 form a capacitor to provide an electric charge in response to the touch driving signal.

As a touching implement touches an eighth point TA52, together at the same time a touching implement touches the seventh point TA51, the touch sensing signal is generated by the adjacent first electrode DL42 and the second electrode from the touch driving signal. The touch sensing signal is transferred to the second electrode TL41 corresponding to the eighth point TA52. The second electrodes TL41 are each connected to the first electrodes SL41 to SL43 through contact points CP51 and CP53.

Next, the touch sensing signals are transferred from each of the second electrodes TL41 to the first electrodes SL41 and SL43. The touch sensing signals are input to the receiving terminal of the touch sensing unit 210 through the corresponding touch wiring.

The signal output unit 20 associates the information from the first electrodes SL44 to SL49 corresponding to the seventh point TA51 with the information from the first electrode DL41 within one frame. The signal output unit 20 also associates information from the first electrodes SL41 to SL43 corresponding to the eighth point TA 52 with the information on the first electrode DL42 within the same frame. The signal output unit 20 outputs the associated information to the touch controller 30.

Next, the touch controller 30 uses the information from the first electrodes SL44 to 49 and the information from the first electrode DL41 to calculate the x-axis coordinates and the y-axis coordinates of the seventh point TA51. Further, the touch controller 30 uses the information from the first electrodes SL41 to SL43 and the information from the first electrode DL42 to calculate the x-axis coordinates and the y-axis coordinates of the eighth point TA52.

Therefore, even when different points are touched, the touch sensing apparatus according to the exemplary embodiment may accurately generate the touch information on different points.

As described above, the exemplary embodiment may reduce the bezel area of the touch sensing apparatus by forming the touch wiring only at one side of the touch panel 10.

According to at least one of the embodiments described above, it is possible to narrow the bezel area of the touch sensing apparatus. Further, according to at least one of the embodiments, it is possible to improve the accuracy of the touch input.

The forgoing embodiments, may be applied to a mobile phone, a smart phone, a laptop computer, a digital broadcasting terminal, personal digital assistants (PDAs), a portable multimedia player (PMP), navigation, a slate PC, a tablet PC, an ultrabook, wearable devices (for example, a watch type terminal (smartwatch), a glass type terminal (smart glass), a head mounted display), a digital TV, a desk top computer, and a digital sign.

The foregoing present invention may implement as codes which may be read by a computer in a medium in which programs are recorded. The medium which may be read by the computer includes all kinds of recording apparatuses in which data read by a computer system are stored. An example of the medium which may be read by the computer may include a hard disk drive (HDD), a solid state disk (SSD), a silicon disk drive (SDD), a ROM, a RAM, a CD-ROM, a magnetic tape, a floppy disk, an optical data storage apparatus, and the like and may include one implemented in a form of a carrier wave (e.g., transmission through the Internet). Further, the computer may also include an application processor of a terminal. Therefore, the foregoing detailed description is not to be restrictively construed in all aspects but should be reckoned as being exemplary. The scope of the present invention is to be determined by a reasonable interpretation of the appending claims and all the changes within an equivalent range of the present invention are included in the scope of the present invention.

Although certain exemplary embodiments and implementations have been described herein, other embodiments and modifications will be apparent from this description. Accordingly, the inventive concept is not limited to such embodiments, but rather to the broader scope of the presented claims and various obvious modifications and equivalent arrangements.

What is claimed is:

1. A touch sensing apparatus, comprising:
a touch panel comprising:
first electrodes extending in a first direction and arranged along a second direction;
second electrodes extending in the second direction and arranged along the first direction;
a signal output unit configured to supply touch driving signals to the first electrodes and configured to receive touch sensing signals generated by the touch driving signals from the first electrodes; and
a touch controller configured to calculate a touch position based on information from at least one of the first electrodes receiving the touch sensing signals and the first electrodes supplying the touch driving signals corresponding to the touch sensing signals, and
wherein the second electrodes are connected to corresponding first electrodes and the second electrodes are configured to transfer the touch sensing signals to the corresponding first electrodes.

2. The touch sensing apparatus of claim 1, wherein:
the second electrodes are disposed adjacent to each other among the second electrodes, and adjacent second electrodes are connected to different first electrodes.

3. The touch sensing apparatus of claim 2, wherein:
the second electrodes are connected to the corresponding first electrodes at a predetermined period of time.

4. The touch sensing apparatus of claim 1, wherein:
the first electrode comprises first connection parts that connect adjacent first pads, and
the second electrode comprises second connection parts that connect adjacent second pads, and
in a region in which the first connection parts and the second connection parts intersect, a portion of the first connection part contacts a portion of the second connection part to connect the second electrode and the first electrode.

5. The touch sensing apparatus of claim 1, wherein:
the touch panel is connected to the signal controller through touch wirings corresponding to the first electrodes.

6. The touch sensing apparatus of claim 5, wherein:
the signal output unit is configured to receive the touch sensing signals through the touch wirings connected to the first electrodes other than the first electrode supplying the touch driving signal.

7. The touch sensing apparatus of claim 6, wherein:
the signal output unit comprises:
a touch driver configured to generate a clock signal that periodically changes to an enable level and scan signals corresponding to the touch wirings; and
a touch sensing unit configured to output the touch driving signals through the touch wirings in response to receiving the clock signal and the scan signals.

8. The touch sensing apparatus of claim 7, wherein:
the touch sensing unit comprises:
a receiving terminal configured to receive the touch sensing signals from the touch wirings and transfer the received touch sensing signals to the touch controller;
first transistors comprising:
gates connected to scan lines configured scan signals,
a first terminal connected to the receiving terminal, and
a second terminal connected to the corresponding touch wiring; and
second transistors configured to complementarily operate with the first transistors and the second transistors comprising:
gates connected to the scan lines that are configured to receive scan signals,
a first terminal configured to receive the clock signal, and
a second terminal connected to the corresponding touch wiring.

9. The touch sensing apparatus of claim 8, wherein:
the touch driver generates the scan signals to maintain a scan signal at an enable level at a timing where the clock signal is also in the enable level.

10. A method for driving a touch sensing apparatus comprising a touch panel, the method comprising:
supplying touch driving signals to first electrodes of the touch panel,
receiving touch sensing signals generated by the touch driving signals from the first electrodes; and
calculating a touched position based on information from at least one of the first electrodes receiving the touch sensing signals and the first electrodes supplying the touch driving signals corresponding to the touch sensing signals,
wherein the first electrodes extend in a first direction and are arranged along a second direction, and the first electrodes are also connected to corresponding second electrode of the touch panel that extend in the second direction are arranged along the first direction.

11. The method of claim 10, wherein:
the supplying of the touch driving signals comprises:
receiving a clock signal that periodically changes to an enable level and scan signals corresponding to the first electrodes; and
outputting the touch driving signal to the first electrode corresponding to a scan signal, when the scan signal is in an enable level and the clock signal is changed to the enable level.

12. The method of claim 11, further comprising:
generating the scan signals to maintain one scan signal at an enable level at a timing at which the clock signal is in the enable level.

13. The method of claim 10, wherein:
the touch driving signals are supplied through touch wirings corresponding to the first electrodes.

14. The method of claim 13, wherein:
the touch sensing signals are received through the touch wirings connected to the first electrodes other than the first electrode supplying the touch driving signal.

15. The method of claim 10, wherein:
adjacent second electrodes are connected to different first electrodes.

16. The method of claim 15, wherein:
the second electrodes are connected to the corresponding first electrodes at a predetermined period.

17. The method of claim 10, wherein:
the first electrode comprises first connection parts that connect adjacent first pads,
the second electrode comprises second connection parts that connect adjacent second pads, and
in a region in where the first connection parts and the second connection parts intersect, a portion of the first connection part contacts a portion of the second connection part to connect the second electrode and the first electrode.
